(19) United States
(12) Patent Application Publication
(10) Pub. No.: US 2018/0107275 A1
(43) Pub. Date: Apr. 19, 2018

(54) DETECTING FACIAL EXPRESSIONS

(71) Applicants: Xiaoqi CHEN, Guangdong (CN); Zhen XIAO, Beijing (CN); Empire Technology Development LLC, Wilmington, DE (US)

(72) Inventors: Xiaoqi CHEN, Guangdong (CN); Zhen XIAO, Beijing (CN)

(73) Assignee: Empire Technology Development LLC, Wilmington, DE (US)

(21) Appl. No.: 15/564,794

(22) PCT Filed: Apr. 13, 2015
(86) PCT No.: PCT/CN2015/076415

§ 371 Date: Oct. 6, 2017

(51) Int. Cl. G06F 3/01; G06T 13/40

(52) U.S. Cl. CPC G06F 3/015; G06F 2203/011; G06T 13/40

(57) ABSTRACT

Embodiments pertaining to techniques of detection of facial expressions are provided. In one aspect, a method may obtain information related to a facial expression of a user. The method may also perform an operation based at least in part on the facial expression.

### TECHNICAL FIELD

The embodiments described herein pertain generally to detection of facial expressions.

### BACKGROUND

Unless otherwise indicated herein, the approaches described in this section are not prior art to the claims in this application and are not admitted to be prior art by inclusion in this section.

In the context of virtual reality simulation, virtual reality scenarios are displayed to a user and, sometimes, with an avatar of the user also displayed in the scenarios. Motions of the user, such as body movements and arm gestures for example, may be captured, e.g., by a camera, and as a result the image of the user displayed in the scenarios may also be shown to make the same motions. Similarly, voice of the user may be captured, e.g., by a microphone, as commands to cause certain effects in the virtual reality scenarios.

### SUMMARY

In one example embodiment, a method may include: obtaining, by a processor of a device, information related to a facial expression of a user; and performing, by the processor, an operation based at least in part on the facial expression.

In another embodiment, a computer-readable storage medium having stored thereon computer-executable instructions executable by one or more processors to perform operations including: detecting a facial expression of a user; and performing an operation based at least in part on the facial expression.

In yet another example embodiment, an apparatus may include a facial expression detection unit configured to detect a facial expression of the user. The apparatus may also include a processor coupled to the facial expression detection unit and configured to perform an operation based at least in part on the facial expression.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

In the detailed description that follows, embodiments are described as illustrations only since various changes and modifications will become apparent to those skilled in the art from the following detailed description. The use of the same reference numbers in different figures indicates similar or identical items.

FIG. 1 shows a front perspective view of an example apparatus capable of detecting facial expressions of a user in accordance with at least some embodiments of the present disclosure.

FIG. 2 shows a rear perspective view of the example apparatus of FIG. 1.

FIGS. 3A and 3B show varying embodiments of a flexible structure capable of detecting movement of a user's skin, in accordance with at least some embodiments of the present disclosure.

FIG. 4 shows another rear perspective view of the example apparatus of FIG. 1.

FIG. 5 shows a side view of a user wearing an example apparatus capable of detecting facial expressions of a user in accordance with at least some embodiments of the present disclosure.

FIG. 6 is a functional block diagram of select components of an example apparatus capable of detecting Facial expressions of a user in accordance with at least some embodiments of the present disclosure.

FIG. 7 shows an example processing flow related to detecting facial expressions of a user in accordance with at least some embodiments of the present disclosure.

FIG. 8 shows another example processing flow related to detecting facial expressions of a user in accordance with at least some embodiments of the present disclosure.

### DETAILED DESCRIPTION

In the following detailed description, reference is made to the accompanying drawings, which form a part of the description. In the drawings, similar symbols typically identify similar components, unless context dictates otherwise. Furthermore, unless otherwise noted, the description of each successive drawing may reference features from one or more of the previous drawings to provide clearer context and a more substantive explanation of the current example embodiment. Still, the example embodiments described in the detailed description, drawings, and claims are not meant to be limiting. Other embodiments may be utilized, and other changes may be made, without departing from the spirit or scope of the subject matter presented herein. It will be readily understood that the aspects of the present disclosure, as generally described herein and illustrated in the drawings, may be arranged, substituted, combined, separated, and designed in a wide variety of different configurations, all of which are explicitly contemplated herein.

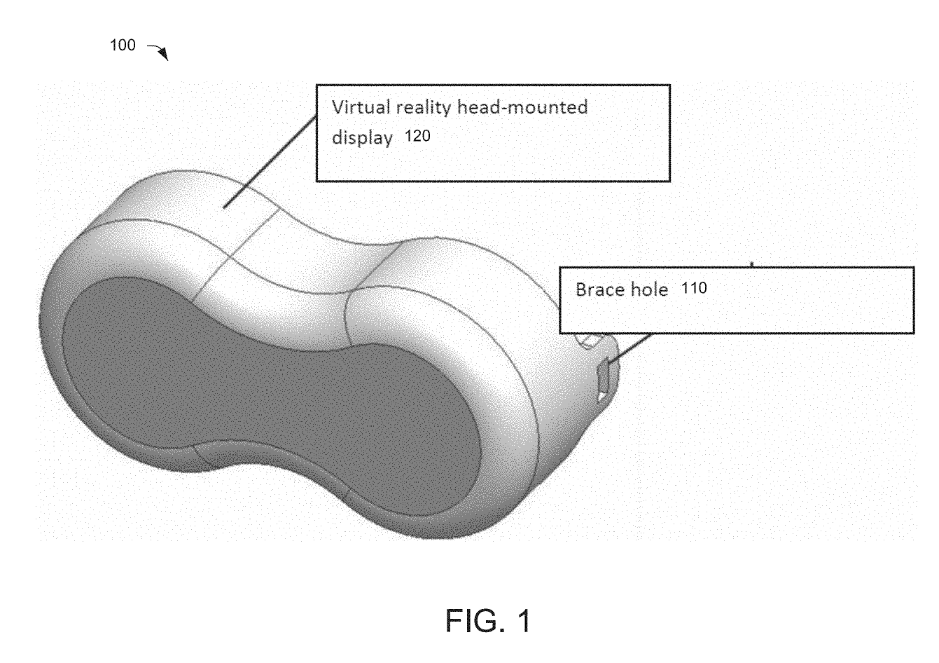

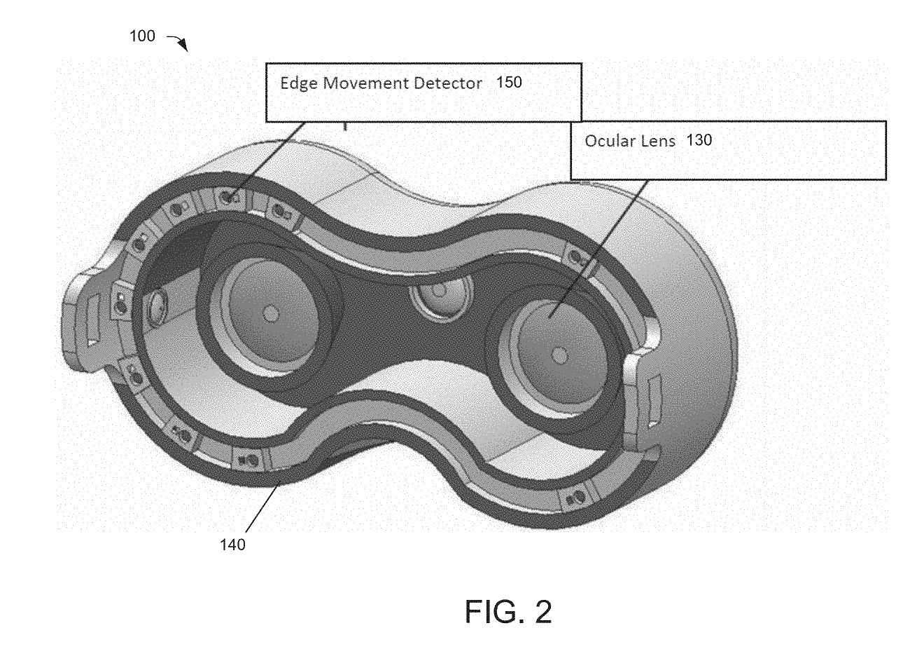

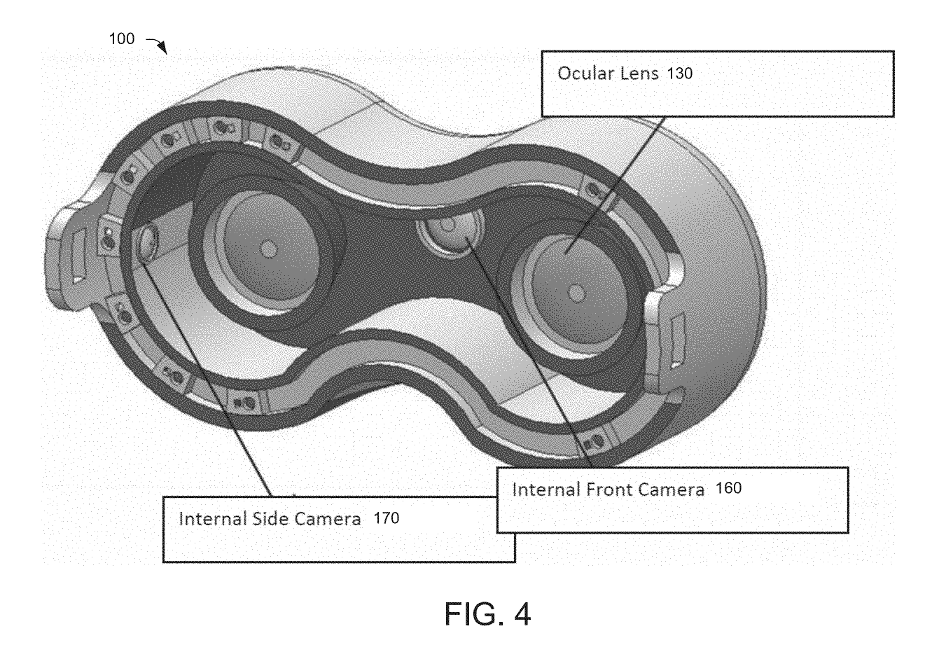

FIG. 1 shows a front perspective view of an example apparatus 100 capable of detecting facial expressions of a user. FIG. 2 and FIG. 4 show rear perspective views of example apparatus 100. Example apparatus 100 may be capable of detecting movements and/or signals indicative of facial expressions of a user and the detected movements and/or signals may be utilized in rendering facial expressions of an image related to the user in a virtual reality setting.

Example apparatus 100 may be configured as a wearable, head-mounted device that a user wears on the face like a diving mask, snorkel mask, a pair of safety goggles or a pair of glasses. When worn by the user, example apparatus 100 may cover the eyes of the user as well as a portion of the face of the user around the eyes. When being worn by the user, example apparatus 100 is in direct contact with or at least very close to the skin of the user around the eyes of the user. Example apparatus 100 may have a nose pad that is in direct contact with the skin of the user around the bridge of the nose of the user to provide support. Example apparatus 100 may be configured to detect and measure movement of the skin around the eyes and the bridge of the nose of the user. Additionally or alternatively, example apparatus 100 may be configured to detect and measure movement of subcutaneous muscular tissues beneath the skin around the eyes and the bridge of the nose of the user.

In some embodiments, example apparatus 100 may employ visible light or near-infrared light of coherent source(s), e.g., one or more lasers, or incoherent source(s), e.g., one or more light-emitting diodes (LEDs), to illuminate the skin to obtain information about skin texture of the user by one or more photoelectric sensors. The illuminated area of the skin may be directly beneath the light source(s). When there is a movement of facial muscles of the user associated with facial expressions, facial skin moves correspondingly and example apparatus 100 may detect the movement of the facial skin at various locations on the face of the user, e.g., by various sensors of example apparatus 100. Based on the detected movement of the facial skin at different locations, example apparatus 100 (or another computing device communicatively connected to example apparatus 100) may deduce the user's facial expression.

Additionally or alternatively, example apparatus 100 may employ coherent or incoherent source(s) of infrared light to illuminate the skin of the user, e.g., at area directly beneath the light source(s). Since infrared light is able to penetrate a certain depth of the human skin and given that the facial skin of the human is relatively thin, subcutaneous muscular tissues of the user may be imaged. For example, example apparatus 100 may employ one or more photoelectric sensors to obtain information about skin texture of the user. When there is a movement of facial muscles of the user associated with facial expressions, example apparatus 100 may measure the direction and amplitude of the movement of each associated facial muscle that is directly beneath a facial contact rim of example apparatus 100.

Additionally or alternatively, the facial contact rim of example apparatus 100 may be equipped with a movable structure that is in direct contact with the skin of the user and is movable to a certain extent relative to the rest of example apparatus 100. The movable structure may include one or more villus-like components or a flexible structure. The movable structure may be connected to a stretch receptor of example apparatus 100 so that movement of the movable structure may be measured. When there is a movement of facial muscles of the user associated with facial expressions, facial skin moves correspondingly and example apparatus 100 may deduce the user's facial expression by measuring the direction and amplitude of the movement of the movable structure.

Additionally or alternatively, example apparatus 100 may include one or more electrodes that, when example apparatus 100 is worn by the user, may be disposed near or put against the facial skin of the user in front of either or both ears of the user to measure electromyography (EMG) signals from various branches of facial nerves of the user. In some embodiments, the one or more electrodes may include one or more dry electrodes.

On the surfaces of example apparatus 100 that face the user when worn by the user (herein interchangeably referred to as the “internal surfaces” of example apparatus 100), there may be one or more cameras configured to capture images of the skin around the eyes of the user for detecting changes in texture of the skin around the eyes of the user. This allows example apparatus 100 to detect the movement of upper and lower eyelids of the user and, hence, to deduce the facial expression of the user. On the surfaces of example apparatus 100 other than the internal surfaces thereof (herein interchangeably referred to as the “exterior surfaces” of example apparatus 100), there may be one or more cameras configured to capture images of the face of the user for detecting movement of various portions of the face, including corners of the mouth of the user, upper and lower kips of the user, and the lower jaw of the user.

In view of the above, example apparatus 100 may be configured to detect movements of facial muscles of the user, movements of upper and lower eyelids of the user, movements of corners of the mouth of the user, movements of the upper and lower lips of the user, and movements of the lower jaw of the user. Based on a combination of the information and data captured by some or all of the above-described detectors, sensors, electrodes, cameras and movable structure pertaining to the aforementioned movements, example apparatus 100 may at least approximately deduce, construct or otherwise estimate the user's entire facial expression. Moreover, example apparatus 100 may be equipped with one or more gyroscopes, accelerometers and/or other positioning devices to estimate the position, orientation, direction and movements of the head of the user. Accordingly, example apparatus 100 may be configured to determine (and reconstruct in a virtual reality image of the user) the expressions of the user's entire face and the position, orientation, direction and movements of the user's head.

Example apparatus 100 may operate in a machine-learning mode and a normal operation mode. When operating in the machine-learning mode, example apparatus 100 may compare movements detected and measured, as well as expressions deduced, to movements and expressions captured by one or more external image capturing devices. In this way, example apparatus 100 may learn, e.g., by storing or otherwise recording relevant data in a memory device that is internal or external of example apparatus 100, about what detected movements correlate to what facial expressions. For example, the user may first make a variety of facial expressions, which are captured by one or more fixed cameras, while EMG signals are measured by example apparatus 100 and recorded by example apparatus 100 or another computing device. Example apparatus 100 or another computing device may then correlate the images of the various facial expressions and corresponding measured EMG signals, and record the correlations, to establish a correlation or relationship between a given facial expression and its corresponding measured EMG signal(s).

When operating in the normal operation mode, example apparatus 100 may compare a given signal associated with a detected movement of a given facial part of the user to stored data of previously-detected signals of known facial expressions to deduce the currently detected facial expression. In some embodiments, a machine-learning model may be established and may be updated dynamically with new measurements so as to improve accuracy of the correlation between measured EMG signals and actual facial expressions. After the machine-learning model is established, the user may wear example apparatus 100 to allow the above-described detectors, sensors, electrodes, cameras and/or movable structure of example apparatus 100 to detect and measure respective movements and/or EMG signals, e.g., in daily life of the user, and facial expressions of the user may be deduced from the machine-learning model.

After data related to facial expressions of the user has been acquired and stored or otherwise recorded, example apparatus 100 or another computing device may utilize such data to generate a virtual image related to the user with dynamic update of facial expression of the virtual image in a real-time manner. The virtual image may be an image of the user, an animated image of the user or another character, or an image capable of showing expressions.

In some embodiments, facial expressions of the user may be used as program operating commands. For example, a blink of an eye by the user may be interpreted as a first command to be executed by example apparatus 100 or another computing device, while the rise of a corner of the mouth of the user may be interpreted as a second command to be executed by example apparatus 100 or another computing device. Accordingly, instead of issuing textual or verbal commands, the user may issue commands by facial expressions to be executed by example apparatus 100 or another computing device.

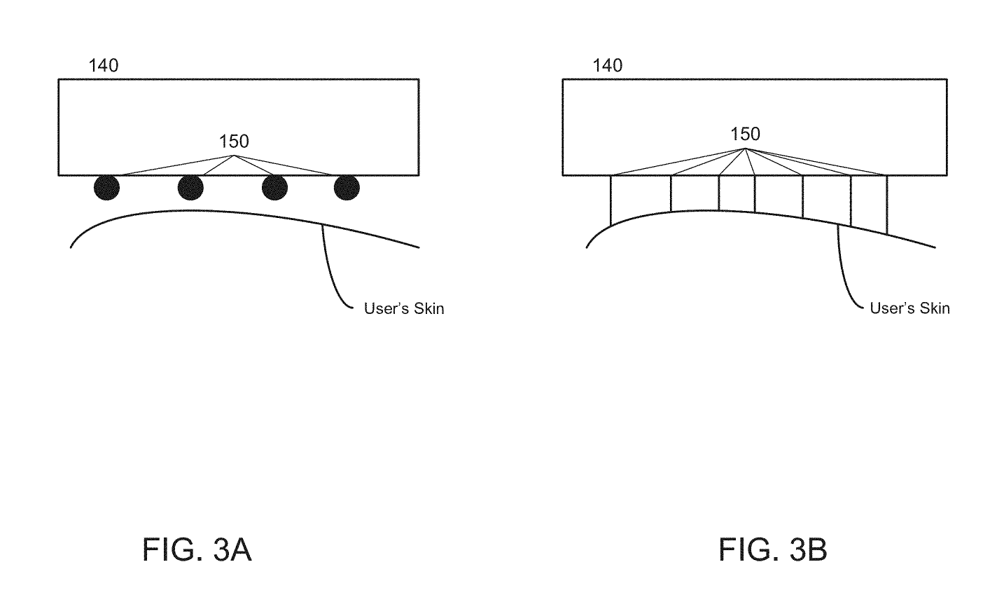

In the example depicted in FIG. 1-FIG. 4, example apparatus 100 has a number of components including, but not limited to, brace holes 110, virtual reality head-mounted display 120 with a pair of ocular lenses 130, facial contact rim 140, one or more edge movement detectors 150, one or more internal front cameras 160 and one or more internal side cameras 170.

Brace holes 110 may be disposed on two opposite sides of example apparatus 100. A strap or strap-like component may go through brace holes 110 to help secure example apparatus 100 to the head and face of the user when worn by the user. Alternatively, spectacle frame may be connected to brace holes 110 in a hinging manner to allow the user wear example apparatus 100 over the ears and bridge of the nose thereof.

Virtual reality head-mounted display 120 may be configured to display images of virtual reality scenarios with an avatar of the user also displayed in the scenarios. The avatar of the user is a graphical representation of the user or an alter ego of the user. The user may view images of the virtual reality scenarios through the pair of ocular lenses 130.

Facial contact rim 140 of example apparatus 100 may come in direct contact with the face of the user when example apparatus 100 is properly worn by the user. The one or more edge movement detectors 150, as shown in FIG. 2A, may be disposed on facial contact rim 140 and configured to detect a movement in a skin texture of the face of the user and/or a movement of one or more subcutaneous muscular tissues of the face of the user. In some embodiments, at least one of the edge movement detectors 150 may include a light source of visible light, near-infrared light, or infrared light configured to illuminate at least a portion of the face of the user. In some embodiments, at least one of the edge movement detectors 150 may include a photo detector or photo sensor configured to sense and measure intensity, or amplitude, of visible light, near-infrared light, or infrared light reflected by the facial skin and/or subcutaneous muscular tissues of the user as well as changes in the reflected light due to movement of the facial skin and/or subcutaneous muscular tissues.

In at least one alternative embodiment, as shown in FIG. 2B, the one or more edge movement detectors 150 may include a plurality of elastic brushes or one or more elastic surfaces. Regardless of the configuration, the shape or configuration one or more edge movement detectors changes in response to sensed movement of the skin texture of the face of the user and/or one or more subcutaneous muscular tissues of the user's face. Each elastic brush, or portions of the elastic surface, may be connected to a stretch receptor disposed within apparatus 100, so that movement of the movable structure may be measured. In some examples, movement may be detected using an electromechanical sensor (such as a piezoelectric or flexoelectric sensor), for example configured to detect deformations such as stretching or other types of strain deformation, and provide an electrical signal correlated with a degree and/or type of deformation. In some examples, an electromechanical sensor may be configured to detect bending, twisting, compression, and the like. In some examples, movement may be detected using an optoelectrical sensor, for example by detecting changes in an optical property in response to a deformation and providing an electrical signal correlated with a degree and/or type of deformation. In some examples, changes in optical transmission through a deformable element, or reflection from an end of an deformable structure (such as a fiber) on bending or other deformation may be detected and used to provide an electrical signal correlated with a deformation.

Each of the one or more front cameras 160 and internal side cameras 170 may be configured to capture images of the eyes of the user as well as the portion of the face surrounding the eyes to detect movement of the eyelids, the skin around the eyes and the bridge of the nose of the user.

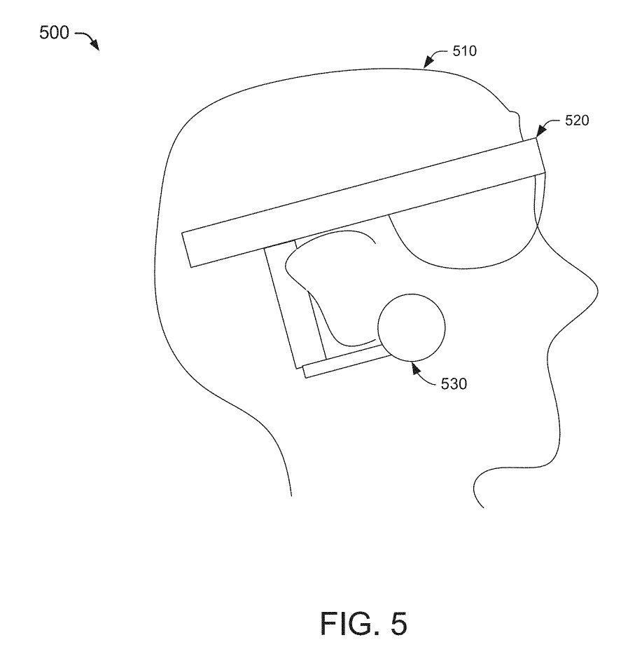

FIG. 5 shows a side view of a user wearing an example apparatus 520 capable of detecting facial expressions of a user in accordance with at least some embodiments of the present disclosure. As shown in FIG. 5, example apparatus 520 is worn on the head of a user 510 with spectacle frames of example apparatus 520 resting on the ears of user 510. Example apparatus 520 may include one or more electrodes 530 that, when example apparatus 520 is worn by user 510 as shown in FIG. 5, may be disposed near or put against the facial skin of user 510 in front of either or both ears of user 510 to measure EMG signals from various branches of facial nerves of user 510. In some embodiments, the one or more electrodes 530 may include one or more dry electrodes.

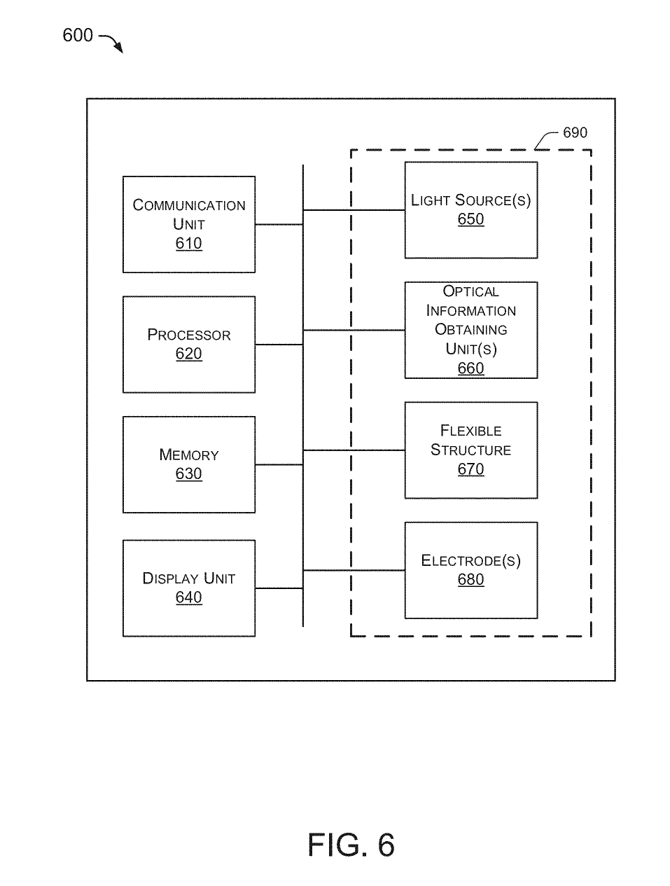

FIG. 6 is a functional block diagram of select components of an example apparatus 600 capable of detecting facial expressions of a user in accordance with at least some embodiments of the present disclosure. Example apparatus 600 may perform various functions related to embodiments of the present disclosure, and may be implemented in or as example apparatus 100 and/or example apparatus 520. Example apparatus 600 may include a communication unit 610, one or more processors (shown as a processor 610 in FIG. 6), a memory 630 and a display unit 640. Communication unit 610 may be configured to allow example apparatus 600 to communicate with other networks, systems, servers, computing devices, etc. Processor 620 may be configured to execute one or more sets of instructions to implement the functionality provided by Example apparatus 600. Memory 630 may be configured to store the one or more sets of instructions executable by processor 620 as well as other data used by processor 620. Display unit 640 may be configured to display virtual reality scenarios with an image of a user therein. Display unit 640 may be implemented as virtual reality head-mounted display 120 as described above.

Example apparatus 600 may also include a facial expression detection unit 690 configured to detect a facial expression of a user, e.g., user 510. Facial expression detection unit 690 may be coupled to processor 620 such that processor 620 may perform an operation based at least in part on the facial expression. In at least some embodiments, processor 620 may execute a command corresponding to the facial expression of the user. In at least some embodiments, processor 620 may generate a virtual image of the user and render the facial expression of the user on the virtual image of the user. For example, processor 620 may cause display unit 640 to display images of virtual reality scenarios with an avatar of the user also displayed in the scenarios. The avatar of the user is a graphical representation of the user or an alter ego of the user. The user may view images of the virtual reality scenarios through a pair of ocular lenses, e.g., ocular lenses 130.

Facial expression detection unit 690 may include one, some or all of the following components: one or more light sources 650, one or more optical information obtaining units 660, a flexible structure 670 and one or more electrodes 680. The one or more optical information obtaining units 660 may include the one or more edge movement detectors 150, when embodied by one or more photo sensors or photodetectors, one or more internal front cameras 160 and one or more internal side cameras 170 as described above. Flexible structure 670 may include one or more edge movement detectors 150, when embodied a plurality of elastic brushes or one or more elastic surfaces.

Each of the one or more light sources 650 may be configured to project a light to illuminate the face of the user. The projected light may include visible light, near-infrared light, or infrared light. At least one of the one or more optical information obtaining units 660 may be configured to obtain information related to the facial expression of the user. In at least some embodiments, the information related to the facial expression of the user may include a movement in a skin texture of the face of the user or a movement of one or more subcutaneous muscular tissues of the face of the user.

The flexible structure 670 may be configured to physically contact the face of the user. At least one of the one or more optical information obtaining units 660 may be configured to detect a movement of the flexible structure 670 as information related to the facial expression of the user.

Each of the one or more electrodes 680 may be in direct contact with the facial skin of the user in front of either or both ears of the user, and may be configured to measure EMG signals generated by facial nerves of the user. Processor 620 may be configured to receive the EMG signals from the facial expression detection unit. Processor 620 may also be configured to compare the measured EMG signals to previously-acquired EMG signals of the user in a machine-learning model to deduce the information related to the facial expression of the user. In at least some embodiments, the machine-learning model may include correlations between the previously-acquired EMG signals of the user and corresponding facial expressions of the user.

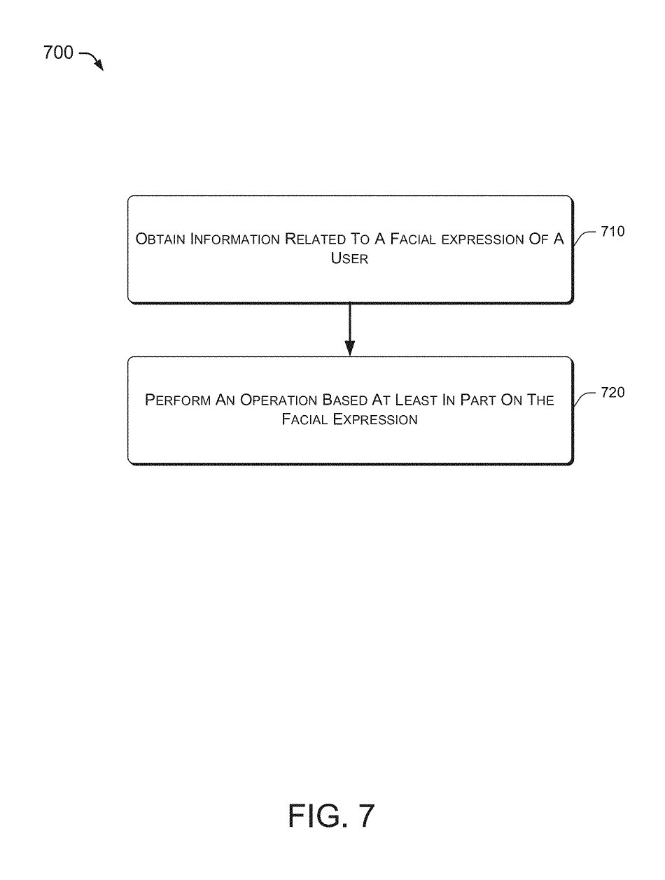

FIG. 7 shows an example processing flow 700 related to detecting facial expressions of a user in accordance with at least some embodiments of the present disclosure. Processing flow 700 may be implemented in example apparatus 100 and example apparatus 520 as described herein. Further, processing flow 700 may include one or more operations, actions, or functions depicted by one or more blocks 710 and 720. Although illustrated as discrete blocks, various blocks may be divided into additional blocks, combined into fewer blocks, or eliminated, depending on the desired implementation. Processing flow 700 may begin at block 710.

At 710 (Obtain Information Related To A Facial Expression Of A User) may refer to one or more processors of example apparatus 100, example apparatus 520 or example apparatus 600 obtaining information related to a facial expression of a user. Block 710 may be followed by block 720.

At 720 (Perform An Operation Based At Least In Part On The Facial Expression) may refer to the one or more processors of example apparatus 100, example apparatus 520 or example apparatus 600 performing an operation based at least in part on the facial expression.

In at least some embodiments, in obtaining information related to the facial expression of the user, processing flow 700 may involve the one or more processors of example apparatus 100, example apparatus 520 or example apparatus 600 illuminating at least a portion of a face of the user by a light. Processing flow 700 may also involve the one or more processors of example apparatus 100, example apparatus 520 or example apparatus 600 obtaining the information related to the facial expression of the user's face, which is illuminated by the light. The light may include visible light, near-infrared light, or infrared light.

In at least some embodiments, in obtaining information related to the facial expression of the user, processing flow 700 may involve the one or more processors of example apparatus 100, example apparatus 520 or example apparatus 600 receiving EMG signals generated by facial nerves of the user. Processing flow 700 may also involve the one or more processors of example apparatus 100, example apparatus 520 or example apparatus 600 comparing the measured EMG signals to previously-acquired EMG signals of the user in a machine-learning model to deduce the information related to the facial expression of the user. The machine-learning model may include correlations between the previously-acquired EMG signals of the user and corresponding facial expressions of the user.

In at least some embodiments, the information related to the facial expression of the user may include a movement in a skin texture of the face of the user.

In at least some embodiments, the information related to the facial expression of the user may include a movement of one or more subcutaneous muscular tissues of the face of the user.

In at least some embodiments, in obtaining information related to the facial expression of the user, processing flow 700 may involve the one or more processors of example apparatus 100, example apparatus 520 or example apparatus 600 detecting a movement of a first component of a device relative to a second component of the device. The first component of the device is in direct contact with a face of the user, and the second component of the device is not in direct contact with the face of the user.

In at least some embodiments, the operation performed may include executing a command corresponding to the facial expression.

In at least some embodiments, the operation performed may include generating a virtual image of the user and rendering the facial expression of the user on the virtual image of the user.

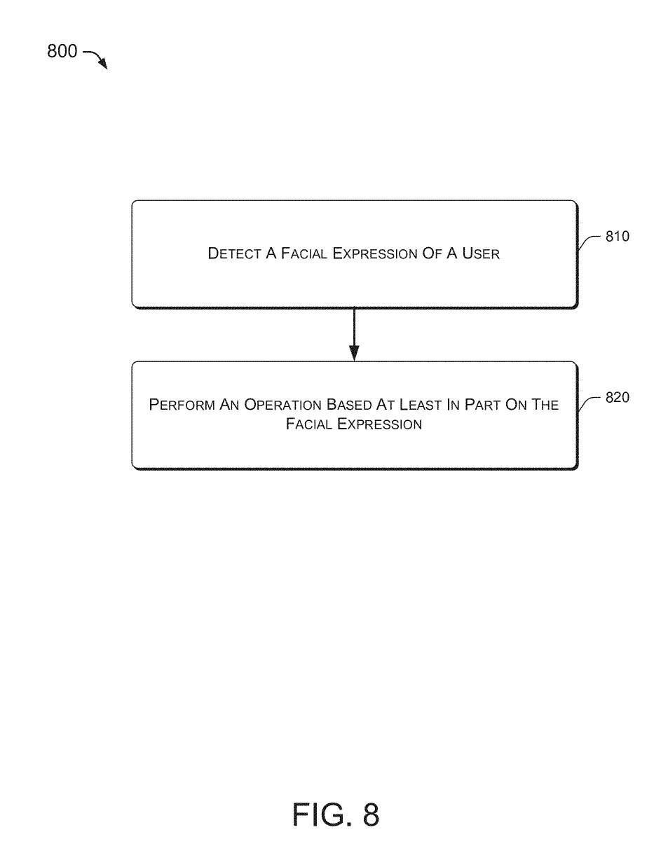

FIG. 8 shows another example processing flow 800 related to detecting facial expressions of a user in accordance with at least some embodiments of the present disclosure. Processing flow 800 may be implemented in example apparatus 100 and example apparatus 520 as described herein. Further, processing flow 800 may include one or more operations, actions, or functions depicted by one or more blocks 810 and 820. Although illustrated as discrete blocks, various blocks may be divided into additional blocks, combined into fewer blocks, or eliminated, depending on the desired implementation. Processing flow 800 may begin at block 810.

At 810 (Detect A Facial Expression Of A User) may refer to one or more processors of example apparatus 100, example apparatus 520 or example apparatus 600 detecting a facial expression of a user.

At 820 (Perform An Operation Based At Least In Part On The Facial Expression) may refer to the one or more processors of example apparatus 100, example apparatus 520 or example apparatus 600 performing an operation based at least in part on the facial expression.

In at least some embodiments, in detecting the facial expression of the user, processing flow 800 may involve the one or more processors of example apparatus 100, example apparatus 520 or example apparatus 600 obtaining information related to the facial expression of the user which is illuminated by visible light, near-infrared light, or infrared light.

In at least some embodiments, the information related to the facial expression of the user may include information indicative of a movement in a skin texture of the face of the user, a movement of one or more subcutaneous muscular tissues of the face of the user, or a movement of a movable structure that is in direct contact with the face of the user.

In at least some embodiments, in detecting the facial expression of the user, processing flow 800 may involve the one or more processors of example apparatus 100, example apparatus 520 or example apparatus 600 receiving EMG signals generated by facial nerves of the user. Processing flow 800 may also involve the one or more processors of example apparatus 100, example apparatus 520 or example apparatus 600 comparing the measured EMG signals to previously-acquired EMG signals of the user in a machine-learning model to deduce the information related to the facial expression of the user. The machine-learning model may include correlations between the previously-acquired EMG signals of the user and corresponding facial expressions of the user.

In at least some embodiments, the operation performed may include executing a command corresponding to the facial expression. Alternatively, the operation performed may include performing operations related to a virtual image of the user by generating the virtual image of the user and rendering the facial expression of the user on the virtual image of the user.

In some examples, an apparatus may be a wearable apparatus configured to be worn on a face of a user, comprising: a facial expression detection unit configured to detect a facial expression of the user; and a processor coupled to the facial expression detection unit and configured to perform an operation based at least in part on the facial expression. In some examples, an apparatus may be supported by a head of a user, for example using a strap, spectacle frame, visor, and the like. In some examples, a facial expression detection unit may comprise one or more light sources configured to project a light to illuminate a face of the user, and may comprise one or more sensors configured to obtain information related to the facial expression of the user. Light may comprise visible light and/or infrared light (IR light), such as near-IR light, mid-IR light, or far-IR light.

In some examples, an apparatus may comprise a head-worn virtual reality (VR) display that includes one or more sensors. One or more sensors may be configured for measuring one or more of skin movement, tissue movement (for example subcutaneous tissue movement), facial expression, eye movement, eyelid movement, eyebrow movement, or other movement of the face or any portion thereof. An apparatus may be configured to determine an intended user input, such as an input command to the apparatus, through any such sensed movement or other aspect of facial expression. In some examples, an apparatus may be (or include) a head-worn display, such as a virtual reality display, that includes one or more sensors for measuring skin movement for determining the user's facial expression or for user input. In some examples, one or more sensors such as skin movement sensors may operate in conjunction with one or more optical sensors (such as one or more cameras) configured to detect movements in at least a portion of the face, such as a portion of the face around the eyes. In some examples, stretch sensors may be disposed around the periphery of an apparatus, configured to be in contact with the skin of the user when the apparatus is worn by the user and provide an electrical signal representative of skin movement and/or external shape of the skin at a particular portion of the face.

In some examples, an apparatus may comprise an image sensor and an associated electronic circuit configured to detect a facial movement, such as a movement of the eye, of skin around the eye, of tissue around the eye, and the like. In some examples, visible and/or IR emitters may be configured to illuminate at least a portion of the face of a user.

In some examples, an apparatus may comprise one or more light sources, such as a visible and/or infrared (IR) light source configured to illuminate at least a portion of the face with visible and/or IR radiation. A sensor, such as an optical sensor, such as an imaging sensor, may be a visible and/or IR sensor configured to detect radiation from a portion of the face, where radiation from the portion of the face may include radiation returned to the sensor from the face by any mechanism, such as specular reflection, multiple reflection, scattering, and the like. In some examples, a sensor may detect thermal radiation from the face. In some examples, a sensor may detect ambient radiation returned from the sensor from the face, where ambient radiation may include sunlight, artificial illumination, and the like. Ambient radiation may augment illumination provided by any light source of the device, if present.

In some examples, a sensor, such as a light sensor, may be configured for detecting skin movement. In some examples, a light source may produce IR light that may penetrate the skin, and reflect from subcutaneous features such as muscles, other tissues, and the like. IR sensors, such as photodetectors, may be configured to measure IR radiation returned from the face.

In some examples, one or more sensors may be disposed around a periphery of a head-mounted display in contact with the skin. Sensors may include sensors providing an electrical response to a movement of the face adjacent or otherwise proximate to the periphery of the head mounted display. Sensors may include piezoelectric sensors, flexoelectric sensors, other strain sensors, and the like.

In some examples, electrodes are provided and configured to measure an electrical signal, such as a nerve signal, when the apparatus is worn by the user. The electrodes may be adjacent or otherwise proximate the skin, and in some examples the electrodes may be urged against the skin, for example by a resilient layer, which may comprise a silicone polymer or other polymer. In some examples, a sensor may comprise a strain gauge configured to provide an electrical signal in response to skin movement, such as stretching, flexing, and the like.

In some examples, one or more skin electrodes may be located to collect electromyographic signals from a position proximate where a facial nerve originates, hence resulting in an improved nerve signal collection.

In some examples, a detected facial expression may be used to produce a dynamic avatar of the user having an expression based on sensor data, or analysis thereof. In some examples, a detected facial expression, or portion thereof, may be used to modify an expression of an avatar of the user, for example an avatar used to represent the user in an augmented reality display. An apparatus may optionally be configured to provide a virtual reality or an augmented reality display to a user, for example using one or more electronic displays viewable by the user. In some examples, the detected facial expression may be a detected partial facial expression, for example relating to a portion of the face around the eyes. In some examples, generation of an avatar facial expression includes generation of a complete facial expression based on a detected partial facial expression (e.g. relating to a portion of the face around the eyes), where the expression of the remaining portion of the face is based on the detected portion, and optionally other data related to the subject, such as detected sound signals, input text, and the like.

In some examples, an apparatus may include a head-worn user interface, which may comprise a near-eye display, and may further include one or more skin sensors allowing monitoring of a facial expression of the user, when the apparatus is worn by the user. In some examples, a representation of the facial expression may then be displayed on a user's avatar (or other representation of the user) presented to one or more other subjects. In some examples, sensor data may be used to provide a command input to the device, such as to a processor of the device. A representation of the facial expression displayed on a user's avatar, or other representation of the user, may be realistic or exaggerated, depending on the application, user selection, and the like.

In some examples, sensor signals may be used to determine a facial expression, for example by correlations of sensor signals with predetermined expressions, training using user input, and the like. In some examples, a user may be requested to form one or more expressions, and sensor signals determined for each expression.

In some examples, a method comprises obtaining, by a processor of a device, information related to a facial expression of a user; and performing, by the processor, an operation based at least in part on the facial expression. In some examples, the method may be a method of determining a user input to the device, such as a command, menu selection, and the like. In some examples, obtaining information related to the facial expression of the user may comprise illuminating at least a portion of a face of the user by a light, and obtaining the information related to the facial expression of the user using light returned from the face of the user, such as reflected and/or scattered light. The light may comprise visible light and/or infrared light (such as near-infrared light). In some examples, obtaining information related to the facial expression of the user comprises receiving electrical signals from electrodes in electrical communication with a portion of the face of the user, such as electromyography (EMG) signals generated by facial nerves of the user. A device may include a head-mounted apparatus, which may include a spectacle frames, goggles (such as augmented reality goggles), helmet, visor, cap, and the like.

In some examples, received electrical signals (such as measured EMG signals) may be compared to previously-acquired electrical signals received from the user, for example using a machine-learning model to determine the information related to the facial expression of the user. A machine-learning model may comprise correlations between previously-acquired electrical signals and corresponding information, such as a facial expression of the user. Similarly, a machine-learning model may be used to analyze detected optical signals, or any other data collected from the user or surroundings thereof.

In some examples, information related to the facial expression of the user may comprise one or more of; a movement in a skin texture of the face of the user (such as a translation, stretching, or other motion), a movement of one or more subcutaneous muscular tissues of the face of the user, a movement of a facial muscle of the user, a movement of an eye of a user, a movement of a mouth of a user, and the like. In some examples, information may comprise one or more of: information related to the eyes of the user (such as gaze direction), information related to eyelids (such as blinking of one or both eyes), information related to eyebrows (such a raised or lowered configuration of one or both eyebrows), or other information related to tissue and/or skin surrounding the eyes. In some examples, information may include information related to a portion of the face covered by a head-mounted apparatus, such as spectacles or goggles.

In some examples, obtaining information related to the facial expression of the user may comprise detecting a movement of a first component of a device relative to a second component of the device, wherein the first component of the device is in direct contact with a face of the user, and wherein the second component of the device is not in direct contact with the face of the user.

In some examples, a method may comprise determining a command by the user from the information related to the facial expression, such as sensor data provided by one or more sensors. In some examples, a method includes executing a command corresponding to the facial expression. For example, the command may be a command related to operation of the apparatus, or other device in communication with the apparatus. A command may be used in improved operation of the apparatus, or other apparatus in communication with the apparatus, such as a computer, game console, transportation device (such as a vehicle), video conferencing device, and the like.

In some examples, an apparatus may be an immersive device, such as a device having the form of goggles, spectacles, helmet, or the like, comprising one or more sensors. In some examples, sensor data or information derived from such sensor data may be used to improve communications with other people, for example by generating an improved avatar or other representation of a user, for example using information related to a facial expression of a user. In some examples, an apparatus may be configured to generate virtual reality, for example using an electronic display, while obtaining user expression information over a similar time period, or simultaneously. A virtual representation may be provided having an improved (e.g. such more accurate, or in some examples exaggerated) representation of a user expression, and in some examples may be used in electronic communications, such as in an improved video communication method. A representation of the user face may be enhanced, for example by removal of blemishes and the like, for example by smoothing algorithm or by user-controlled modification of the representation. The expression of the representation may be more accurately portrayed using information relating to the facial expression.

In some examples, sensors may be used to both perform command input to the apparatus, and to determine a facial expression. In some example, sensor data may be used to for physiological monitoring of a user. In some examples, biofeedback may be provided to the user, such as recommendation against electronic communication while in a physiologically agitated state.

In interpersonal communication, internal emotions are not necessarily consistent with an expressions displayed. Hence, some examples described herein may be advantageous over use of an EEG or other brain-derived electrical signal to control electronically displayed expression and/or emotion (e.g. through use of an avatar). Examples of the present approach allow a user to be represented by an avatar or other electronic representation showing a polite expression, regardless of internal unhappiness, with an accurate representation of the actual polite expression of the user being represented by an avatar or other representation of the user.

### CONCLUSION AND ADDITIONAL NOTES

It will be understood by those within the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

Lastly, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

From the foregoing, it will be appreciated that various embodiments of the present disclosure have been described herein for purposes of illustration, and that various modifications may be made without departing from the scope and spirit of the present disclosure. Accordingly, the various embodiments disclosed herein are not intended to be limiting, with the true scope and spirit being indicated by the following claims.

1. A method, comprising:
obtaining, by a processor of a device, information related to a facial expression of a user; and
performing, by the processor, an operation based at least, in part, on the facial expression.

2. The method of claim 1, wherein the obtaining the information related to the facial expression of the user comprises:
illuminating at least a portion of a face of the user by a light; and
obtaining, based on the illumination, the information related to the facial expression of the user, wherein the light comprises one or more of: visible light, near-infrared light, or infrared light.

3. The method of claim 1, wherein the obtaining the information related to the facial expression of the user comprises:
receiving electromyography (EMG) signals generated by facial nerves of the user; and
comparing the received EMG signals to previously-acquired EMG signals of the user, in a machine-learning model, to deduce the information related to the facial expression of the user, wherein the machine-learning model comprises correlations between the previously-acquired EMG signals of the user and corresponding facial expressions of the user.

4. The method of claim 1, wherein the information related to the facial expression of the user comprises a movement in a skin texture of a face of the user.

5. The method of claim 1, wherein the information related to the facial expression of the user comprises a movement of one or more subcutaneous muscular tissues of a face of the user.

6. The method of claim 1, wherein the obtaining the information related to the facial expression of the user comprises detecting a movement of a first component of the device relative to a second component of the device, wherein the first component of the device is in direct contact with a face of the user, and wherein the second component of the device is not in direct contact with the face of the user.

7. The method of claim 1, wherein the performing the operation comprises executing a command that corresponds to the facial expression.

8. The method of claim 1, wherein the performing the operation comprises:
generating a virtual image of the user; and
rendering the facial expression of the user on the virtual image of the user.

9. A non-transitory computer-readable storage medium having stored thereon computer-executable instructions that, in response to execution by one or more processors, cause the one or more processors to perform or control performance of operations, comprising:
detecting a facial expression of a user; and
performing an operation based at least, in part, on the facial expression.

10. The non-transitory computer-readable storage medium of claim 9, wherein the detecting the facial expression of the user comprises obtaining information related to the facial expression of the user based on illumination of at least a portion of a face of the user by one or more of: visible light, near-infrared light, or infrared light.

11. The non-transitory computer-readable storage medium of claim 10, wherein the information related to the facial expression of the user comprises information indicative of a movement in a skin texture of a face of the user, a movement of one or more subcutaneous muscular tissues of the face of the user, or a movement of a movable structure that is in direct contact with the face of the user.

12. The non-transitory computer-readable storage medium of claim 9, wherein the detecting the facial expression of the user comprises obtaining information related to the facial expression of the user by:
receiving electromyography (EMG) signals generated by facial nerves of the user; and
comparing the received EMG signals to previously-acquired EMG signals of the user, in a machine-learning model, to deduce the information related to the facial expression of the user, wherein the machine-learning model comprises correlations between the previously-acquired EMG signals of the user and corresponding facial expressions of the user.

13. The non-transitory computer-readable storage medium of claim 9, wherein the performing the operation comprises:
executing a command that corresponds to the facial expression; or
performing operations related to a virtual image of the user by:
generating the virtual image of the user; and
rendering the facial expression of the user on the virtual image of the user.

14. A wearable apparatus configured to be worn on a face of a user, the wearable apparatus comprising:
a facial expression detection unit configured to detect a facial expression of the user; and
a processor coupled to the facial expression detection unit and configured to perform an operation based at least, in part, on the facial expression.

15. The wearable apparatus of claim 14, wherein the facial expression detection unit comprises:
one or more light sources configured to project a light to illuminate the face of the user, wherein the light comprises one or more of: visible light, near-infrared light, or infrared light; and
one or more sensors configured to obtain information related to the facial expression of the user.

16. The wearable apparatus of claim 15, wherein the information related to the facial expression of the user comprises a movement in a skin texture of the face of the user or a movement of one or more subcutaneous muscular tissues of the face of the user.

17. The wearable apparatus of claim 14, wherein the facial expression detection unit comprises:
at least one electrode in direct contact with a skin of the user in front of either or both ears of the user, wherein the at least one electrode is configured to measure electromyography (EMG) signals generated by facial nerves of the user, and wherein the processor is configured to:
receive the EMG signals from the facial expression detection unit; and
compare the received EMG signals to previously-acquired EMG signals of the user, in a machine-learning model, to deduce the information related to the facial expression of the user, wherein the machine-learning model comprises correlations between the previously-acquired EMG signals of the user and corresponding facial expressions of the user.

18. The wearable apparatus of claim 14, wherein the facial expression detection unit comprises:
a flexible structure configured to physically contact the face of the user; and
one or more sensors configured to detect a movement of the flexible structure as information related to the facial expression of the user.

19. The wearable apparatus of claim 14, wherein to perform the operation, the processor is configured to execute a command that corresponds to the facial expression.

20. The wearable apparatus of claim 14, wherein to perform the operation, the processor is configured to:
generate a virtual image of the user; and
render the facial expression of the user on the virtual image of the user.
